(19) United States
(12) Patent Application Publication
(10) Pub. No.: US 2025/0192321 A1
(43) Pub. Date: Jun. 12, 2025

(54) BATTERY PACK

(71) Applicant: Samsung SDI Co., Ltd., Yongin-si (KR)

(72) Inventors: Sang Do HUR, Yongin-si (KR); Han Jun WANG, Yongin-si (KR)

(21) Appl. No.: 18/734,483

(22) Filed: Jun. 5, 2024

(30) Foreign Application Priority Data
Dec. 11, 2023 (KR) 10-2023-0178497

(51) Int. Cl. H01M 50/264; H01M 50/211; H01M 50/242

(52) U.S. Cl. CPC H01M 50/264; H01M 50/211; H01M 50/242

(57) ABSTRACT

The present disclosure provides a battery pack including battery cells including an electrode assembly in a pouch case and including one or more electrode tabs, and a fixing member between the battery cells to fix the battery cells, and defining through-holes passing from one end thereof to another end thereof.

### CROSS-REFERENCE TO RELATED APPLICATION

The present application claims priority to and the benefit of Korean Patent Application No. 10-2023-0178497, filed on Dec. 11, 2023, in the Korean Intellectual Property Office, the entire disclosure of which is incorporated herein by reference.

### BACKGROUND

### 1. Field

Aspects of embodiments of the present disclosure relate to a battery pack.

### 2 Description of the Related Art

Secondary batteries are batteries that can be charged and discharged, unlike primary batteries, which cannot be recharged. Low-capacity batteries, in which one battery cell is packaged in a pack form, may be used in small portable electronic devices, such as smartphones and digital cameras, while high-capacity batteries in the form of a module, in which tens to hundreds of battery packs are connected, may be used as power sources to drive motors for hybrid vehicles, electric vehicles, power tools, hand cleaners, or drones, or may be used as energy storage devices.

A battery pack can be configured using either circular cells or pouch cells. If the battery pack is configured using pouch cells, the output power may be increased in the same area, as compared to circular cells, and the weight of the pack can be reduced. A secondary battery may include an electrode assembly composed of a positive electrode and a negative electrode, a case accommodating the electrode assembly, and electrode terminals connected to the electrode assembly.

The above information disclosed in this background section is only for enhancement of understanding of the background of the present disclosure, and therefore may include information that does not constitute the related art.

### SUMMARY

Aspects of embodiments of the present disclosure may be directed to providing a battery pack in which perforated holes are formed/defined in a fixing member located between, and configured to fix, respective cells so that cell movement may be suppressed, and so that cell swelling may be absorbed.

However, aspects of the present disclosure are not limited to those described above, and other aspects that are not mentioned may be clearly understood by those skilled in the art from the description of the present disclosure provided below.

An aspect of the present disclosure provides a battery pack including battery cells including an electrode assembly in a pouch case and including one or more electrode tabs, and a fixing member between the battery cells to fix the battery cells, and defining through-holes passing from one end thereof to another end thereof.

The through-holes may have a circular cross section.

The through-holes may have an oval cross section with a long axis parallel to a width direction of the battery cells.

The fixing member may include one of silicone rubber, urethane, or ethylene vinyl acetate (EVA).

A minimum diameter of the through-holes may correspond to a compression rate of the fixing member based on a swelling of the battery cells.

The fixing member may have a hexahedral shape including four side surfaces, and two wide surfaces contacting the battery cells.

The through-holes may pass from one side surface among the four side surfaces to another side surface opposite thereto.

The through-holes may be parallel to a longitudinal direction of the battery cells.

The through-holes may be parallel to a direction in which the electrode tabs protrude.

The through-holes may be perpendicular to a longitudinal direction of the battery cells.

The through-holes may be side by side.

The through-holes may include a first through-hole parallel to a longitudinal direction of the battery cells, and a second through-hole perpendicular to the longitudinal direction of the battery cells.

The first through-hole and the second through-hole may cross each other.

An area of one of the wide surfaces of the fixing member may be less than or equal to an area of a surface of the battery cell contacting the one of the wide surfaces.

The fixing member may further include an adhesive member at one of the wide surfaces.

A minimum thickness of the fixing member between the one of the wide surfaces and one of the through-holes may be about 10% to about 30% of a maximum thickness of the fixing member between the wide surfaces.

The adhesive member may include an acrylic material.

The adhesive member may have an adhesive strength of about 1300 g/25.4 mm or more.

The adhesive member may have a thickness of about 10% or less than a thickness of a remainder of the fixing member excluding the adhesive member.

The battery cells may be stacked in a stack type.

### BRIEF DESCRIPTION OF DRAWINGS

FIG. 1 is a perspective view of a battery cell according to one or more embodiments of the present disclosure.

FIG. 2 is a perspective view of a battery pack composed of battery cells of FIG. 1.

FIG. 3 is a perspective view of a fixing member in which through-holes are formed parallel to a longitudinal direction (y-axis direction) of the battery cell according to one or more embodiments of the present disclosure.

FIG. 4 is a perspective view of a fixing member in which through-holes are formed perpendicular to the longitudinal direction (y-axis direction) of the battery cell according to one or more embodiments of the present disclosure.

FIGS. 5A and 5B are a perspective view and a cross-sectional view of a fixing member in which through-holes are formed to be parallel to and perpendicular to the longitudinal direction (y-axis direction) of the battery cell according to one or more embodiments of the present disclosure.

FIG. 6 is a front view of a fixing member in which circular through-holes are formed according to one or more embodiments of the present disclosure.

FIG. 7 is a front view of a fixing member in which generally oval through-holes are formed according to one or more embodiments of the present disclosure.

### DETAILED DESCRIPTION

Aspects of some embodiments of the present disclosure and methods of accomplishing the same may be understood more readily by reference to the detailed description of embodiments and the accompanying drawings. The described embodiments are provided as examples so that this disclosure will be thorough and complete, and will fully convey the aspects of the present disclosure to those skilled in the art. Accordingly, processes, elements, and techniques that are redundant, that are unrelated or irrelevant to the description of the embodiments, or that are not necessary to those having ordinary skill in the art for a complete understanding of the aspects of the present disclosure may be omitted. Unless otherwise noted, like reference numerals, characters, or combinations thereof denote like elements throughout the attached drawings and the written description, and thus, repeated descriptions thereof may be omitted.

The described embodiments may have various modifications and may be embodied in different forms, and should not be construed as being limited to only the illustrated embodiments herein. The use of “can,” “may,” or “may not” in describing an embodiment corresponds to one or more embodiments of the present disclosure. The present disclosure covers all modifications, equivalents, and replacements within the idea and technical scope of the present disclosure. Further, each of the features of the various embodiments of the present disclosure may be combined with each other, in part or in whole, and technically various interlocking and driving are possible. Each embodiment may be implemented independently of each other or may be implemented together in an association.

In the drawings, the relative sizes of elements, layers, and regions may be exaggerated for clarity and/or descriptive purposes. Various embodiments are described herein with reference to sectional illustrations that are schematic illustrations of embodiments and/or intermediate structures. As such, variations from the shapes of the illustrations as a result of, for example, manufacturing techniques and/or tolerances, are to be expected. Further, specific structural or functional descriptions disclosed herein are merely illustrative for the purpose of describing embodiments according to the concept of the present disclosure. Thus, embodiments disclosed herein should not be construed as limited to the illustrated shapes of elements, layers, or regions, but are to include deviations in shapes that result from, for instance, manufacturing.

Spatially relative terms, such as “beneath,” “below,” “lower,” “lower side,” “under,” “above,” “upper,” “upper side,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below,” “beneath,” “or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly. Similarly, when a first part is described as being arranged “on” a second part, this indicates that the first part is arranged at an upper side or a lower side of the second part without the limitation to the upper side thereof on the basis of the gravity direction.

Further, the phrase “in a plan view” means when an object portion is viewed from above, and the phrase “in a schematic cross-sectional view” means when a schematic cross-section taken by vertically cutting an object portion is viewed from the side. The terms “overlap” or “overlapped” mean that a first object may be above or below or to a side of a second object, and vice versa. Additionally, the term “overlap” may include stack, face or facing, extending over, covering, or partly covering or any other suitable term as would be appreciated and understood by those of ordinary skill in the art. The expression “not overlap” may include meaning, such as “apart from” or “set aside from” or “offset from” and any other suitable equivalents as would be appreciated and understood by those of ordinary skill in the art. The terms “face” and “facing” may mean that a first object may directly or indirectly oppose a second object. In a case in which a third object intervenes between a first and second object, the first and second objects may be understood as being indirectly opposed to one another, although still facing each other.

It will be understood that when an element, layer, region, or component is referred to as being “formed on,” “on,” “connected to,” or “(operatively or communicatively) coupled to” another element, layer, region, or component, it can be directly formed on, on, connected to, or coupled to the other element, layer, region, or component, or indirectly formed on, on, connected to, or coupled to the other element, layer, region, or component such that one or more intervening elements, layers, regions, or components may be present. In addition, this may collectively mean a direct or indirect coupling or connection and an integral or non-integral coupling or connection. For example, when a layer, region, or component is referred to as being “electrically connected” or “electrically coupled” to another layer, region, or component, it can be directly electrically connected or coupled to the other layer, region, and/or component or one or more intervening layers, regions, or components may be present. The one or more intervening components may include a switch, a resistor, a capacitor, and/or the like. In describing embodiments, an expression of connection indicates electrical connection unless explicitly described to be direct connection, and “directly connected/directly coupled,” or “directly on,” refers to one component directly connecting or coupling another component, or being on another component, without an intermediate component.

In addition, in the present specification, when a portion of a layer, a film, an area, a plate, or the like is formed on another portion, a forming direction is not limited to an upper direction but includes forming the portion on a side surface or in a lower direction. On the contrary, when a portion of a layer, a film, an area, a plate, or the like is formed “under” another portion, this includes not only a case where the portion is “directly beneath” another portion but also a case where there is further another portion between the portion and another portion. Meanwhile, other expressions describing relationships between components, such as “between,” “immediately between” or “adjacent to” and “directly adjacent to,” may be construed similarly. It will be understood that when an element or layer is referred to as being “between” two elements or layers, it can be the only element or layer between the two elements or layers, or one or more intervening elements or layers may also be present.

For the purposes of this disclosure, expressions such as “at least one of,” or “any one of,” or “one or more of” when preceding a list of elements, modify the entire list of elements and do not modify the individual elements of the list. For example, “at least one of X, Y, and Z,” “at least one of X, Y, or Z,” “at least one selected from the group consisting of X, Y, and Z,” and “at least one selected from the group consisting of X, Y, or Z” may be construed as X only, Y only, Z only, any combination of two or more of X, Y, and Z, such as, for instance, XYZ, XYY, YZ, and ZZ, or any variation thereof. Similarly, the expressions “at least one of A and B” and “at least one of A or B” may include A, B, or A and B. As used herein, “or” generally means “and/or,” and the term “and/or” includes any and all combinations of one or more of the associated listed items. For example, the expression “A and/or B” may include A, B, or A and B. Similarly, expressions such as “at least one of,” “a plurality of,” “one of,” and other prepositional phrases, when preceding a list of elements, modify the entire list of elements and do not modify the individual elements of the list.

It will be understood that, although the terms “first,” “second,” “third,” etc., may be used herein to describe various elements, components, regions, layers and/or sections, these elements, components, regions, layers and/or sections should not be limited by these terms. These terms do not correspond to a particular order, position, or superiority, and are used only used to distinguish one element, member, component, region, area, layer, section, or portion from another element, member, component, region, area, layer, section, or portion. Thus, a first element, component, region, layer or section described below could be termed a second element, component, region, layer or section, without departing from the spirit and scope of the present disclosure. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-category (or first-set),” “second-category (or second-set),” etc., respectively.

In the examples, the x-axis, the y-axis, and/or the z-axis are not limited to three axes of a rectangular coordinate system, and may be interpreted in a broader sense. For example, the x-axis, the y-axis, and the z-axis may be perpendicular to one another, or may represent different directions that are not perpendicular to one another. The same applies for first, second, and/or third directions.

The terminology used herein is for the purpose of describing embodiments only and is not intended to be limiting of the present disclosure. As used herein, the singular forms “a” and “an” are intended to include the plural forms as well, while the plural forms are also intended to include the singular forms, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

As used herein, the term “substantially,” “about,” “approximately,” and similar terms are used as terms of approximation and not as terms of degree, and are intended to account for the inherent deviations in measured or calculated values that would be recognized by those of ordinary skill in the art. For example, “substantially” may include a range of +/−5% of a corresponding value. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within +30%, 20%, 10%, 5% of the stated value. Further, the use of “may” when describing embodiments of the present disclosure refers to “one or more embodiments of the present disclosure.”

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

Hereinafter, in illustrative examples of a prismatic battery according to one or more embodiments of the present disclosure, a battery selected from one of the prismatic batteries is described as having a general structure. The general structure of the prismatic battery is described with respect to a generally applied technology. However, the present disclosure is not limited thereto, and a case may be configured in various shapes, such as a circular shape or a pouch shape. In one or more embodiments, the case may be made of a metal, such as aluminum, an aluminum alloy, or nickel-plated steel, or may be made of a laminated film or plastic for forming a pouch.

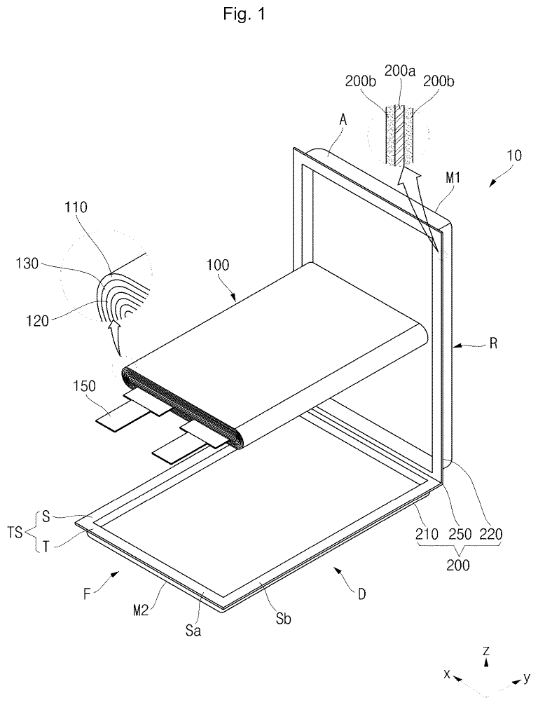

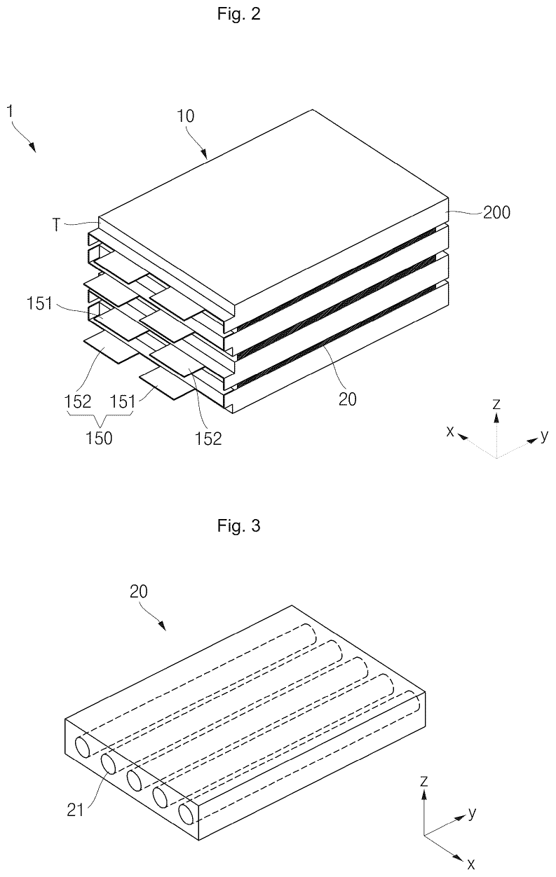

FIG. 1 is a perspective view of a battery cell according to one or more embodiments of the present disclosure, and FIG. 2 is a perspective view of a battery pack composed of battery cells of FIG. 1.

The battery cell 10 may be a battery cell of a circular type, a prismatic type, or a pouch type, depending on a shape of the battery, and according to different embodiments. A pouch type battery cell 10 is shown in FIG. 1. FIG. 2 partially shows some of a plurality of battery cells of a battery pack.

Referring to FIGS. 1 and 2, the battery pack 1 according to one or more embodiments of the present disclosure may include two or more battery cells 10, and a cell holder by which the battery cells 10 are assembled. The cell holder functions to support the plurality of battery cells 10, and the plurality of battery cells 10 are assembled to be inserted into the cell holder to maintain a fixed position. The cell holder may structurally bundle-bind the plurality of battery cells 10 into a module unit. The plurality of battery cells 10 may be arranged in one direction so that respective wide surfaces of the battery cells 10 face each other.

In one or more embodiments, the battery pack 1 may include one or more battery modules in which the plurality of battery cells 10 are assembled, and a pack housing in which an accommodating space is formed to accommodate the one or more battery modules. The battery module may include the plurality of battery cells 10 and a module housing.

The battery cell 10 may include a receiving part A that accommodates an electrode assembly 100, and a sealing part TS extending along an edge of the receiving part A to seal the receiving part A. The electrode assembly 100 may be in a roll form in which first and second electrode plates 110 and 120, which face each other, are wound with a separator 130 interposed therebetween. The electrode assembly 100 may be in a stack form in which the first and second electrode plates 110 and 120 are stacked with a separator 130 interposed therebetween.

An electrode tab 150 forming a charge and discharge path may be connected to the electrode assembly 100. The electrode tab 150 may include two electrode tabs 150 of different polarities that are electrically connected to the electrode assembly 100. The electrode tab 150 connected to the electrode assembly 100 within the receiving part A may be drawn outward through a front surface F of the receiving part A. The electrode tab 150 may include a positive electrode tab 151 and a negative electrode tab 152.

The receiving portion A in which the electrode assembly 100 is accommodated may be formed in a substantially rectangular parallelepiped shape. In some examples, an exterior of the battery cell 10 may generally follow an exterior of the receiving part A.

In one or more embodiments, the receiving portion A may include a front surface F from which the electrode tab 150 is drawn, and a rear surface R opposite to the front surface F. The receiving portion A may include a pair of main surfaces M connecting the front surface F and the rear surface R, and a pair of side surfaces D connecting the front surface F and the rear surface R. The main surfaces M may occupy the largest area among the surfaces of the receiving portion A. The main surfaces M and the side surfaces D may be respectively formed as pairs at positions opposite to each other. For example, the main surfaces M may include first and second main surfaces M1 and M2 opposite to each other. In one or more embodiments, the electrode assembly 100 is formed on the first and second main surfaces M1 and M2 of the receiving portion A in FIG. 1, but a recess having a depth may be formed in only one of the first or second main surfaces M1 or M2 to accommodate the electrode assembly 100

The receiving part A for accommodating the electrode assembly 100, and the sealing part TS for sealing the receiving part A, may be formed from an exterior finishing material 200 continuously formed to surround the electrode assembly 100. The exterior finishing material 200 may be formed of a flexible exterior finishing material, such as a pouch. In one or more embodiments, the exterior finishing material 200 may include a metal layer 200a, such as an aluminum sheet, and may include an insulating layer 200b, such as a resin coating layer formed on both surfaces of the metal layer 200a. In this case, the metal layer 200a may be exposed to an exterior through a cross section where the exterior finishing material 200 terminates.

In some examples, the exterior finishing material 200 may include first and second exterior finishing materials 210 and 220 that are coupled to face each other with the electrode assembly 100 interposed therebetween. With the electrode assembly 100 interposed between the first and second exterior finishing materials 210 and 220, the first and second exterior finishing materials 210 and 220 may be folded to be stacked on each other through a folding portion 250 that connects the first and second exterior finishing materials 210 and 220 to each other. Thereafter, the portions in contact with each other along the edge areas of the first and second exterior finishing materials 210 and 220 may be bonded to each other by heat fusion or the like, such that the inner areas of the first and second exterior finishing materials 210 and 220, which face each other with the electrode assembly 100 interposed therebetween, may be formed as a receiving part A, and such that the edge areas of the first and second exterior finishing materials 210 and 220 bonded to each other may be formed as a sealing part TS.

The sealing part TS may include a terrace portion T extending toward the front surface F of the receiving portion A, and a side sealing portion S extending toward the side surface of the receiving portion A. In this case, the electrode tab 150 connected to the electrode assembly 100 within the accommodating part A may be drawn out of the receiving portion A through the terrace portion T extending toward the front surface F of the receiving portion A. In one or more embodiments, a protection circuit module may be seated on the terrace portion T, and the electrode tab 150 drawn out through the terrace portion T may be bent to be connected to the protection circuit module seated on the terrace portion T.

The side sealing portion S may include a main body Sb of the side sealing portion S at a position corresponding to the receiving part A, and a front end Sa of the side sealing portion S extending from the main body Sb of the side sealing portion S to a position separated from the receiving part A. The side sealing portion S may be folded toward the receiving portion A to reduce an area occupied by the entire battery cell 10.

In one or more embodiments, the battery pack 1 that uses high output power, such as a battery pack for power tools and hand cleaners, may be generally composed of circular cells assembled to be connected in series and parallel. In one or more embodiments, pouch cells may be used to increase output power within the same area while lowering a weight of the pack. In a pack configuration using the pouch cells, each of the cells may be stacked in a stack type to be configured within a secured area, unlike circular cells. To stack the pouch cells, the cells may be assembled and fixed using a fixing member, such as a fixing tape.

A material of the fixing tape may be polyurethane, silicone, etc. The suitable performance of a fixing tape may include a corresponding level of adhesion to mechanically combine and connect each cell (high adhesion treatment), and materials to reduce or minimize the cell movement in the longitudinal direction (y-direction) of each cell in the event of external impact, such as falling (high hardness material) should be employed. In one or more embodiments, to reduce or minimize dead space due to tape volume (thickness), it may be suitable to have a cushion (compression) force to absorb swelling that occurs during a decrease in the lifetime of the pouch cell.

There may generally be a trade-off between high-hardness materials for movement suppression, and materials with an excellent compression rate. For example, with respect to cushioning materials (e.g., sponge and rubber), for the sponge type (e.g., a material with an excellent compression rate), the thickness may be selected by reflecting cell swelling as much as the compression rate, although cell movement may not be suppressed, and as a result some cells may be impacted in a fall. In one or more embodiments, a rubber type (e.g., a material with relatively high hardness) may be effective in suppressing the movement of the cell, although a rubber type might not be effective in absorbing the amount of cell swelling, which may result in volume loss.

One or more embodiments of the present disclosure provide a fixing member 20 capable of securing high hardness to suppress movement in the longitudinal direction (y-direction) of the battery cell 10, and capable of securing a high compression rate to absorb swelling in the stacked direction (z-direction). In some examples, the fixing member 20 may be manufactured with a design in which the through-holes are formed in the fixing member, based on a material with a high hardness, by an extrusion molding method. In the longitudinal direction (y-direction) of the battery cell 10, hardness of a raw material may be maintained as much as possible to suppress the movement of the cell, and in the stacked direction (z-direction), the compression rate may be increased by an external force (cell swelling) by perforated holes. A structure of the fixing member 20 will be described below.

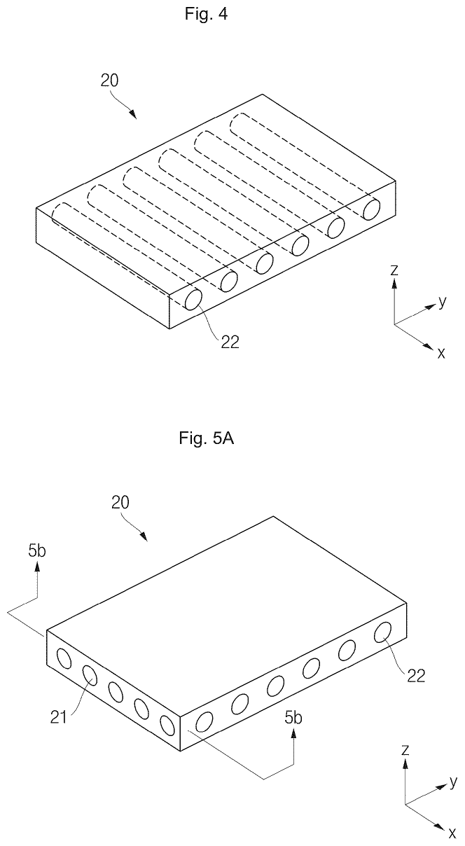

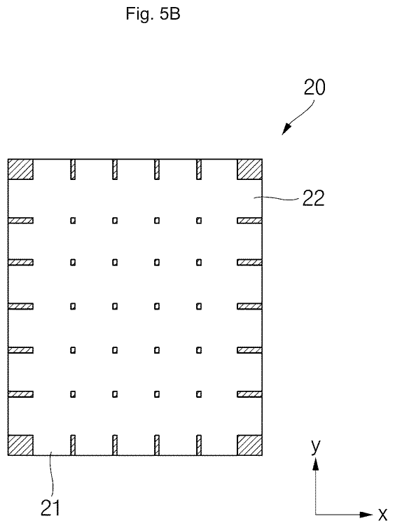

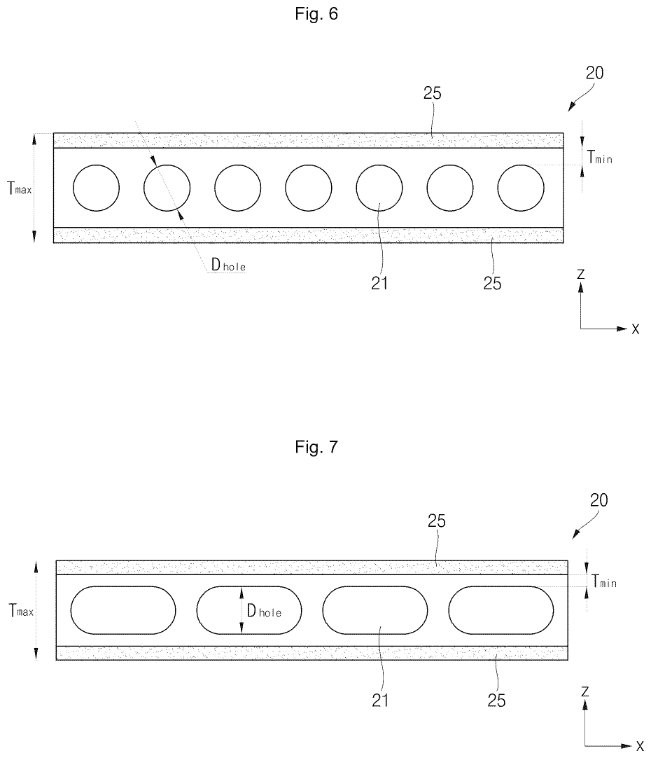

FIG. 3 is a perspective view of a fixing member in which through-holes are formed parallel to the longitudinal direction y of the battery cell according to one or more embodiments of the present disclosure. FIG. 4 is a perspective view of a fixing member in which through-holes are formed perpendicular to the longitudinal direction y of the battery cell according to one or more embodiments of the present disclosure. FIGS. 5A and 5B are a perspective view and a cross-sectional view of a fixing member in which through-holes are formed parallel and perpendicular to the longitudinal direction y of the battery cell according to one or more embodiments of the present disclosure. FIG. 6 is a front view of a fixing member in which circular through-holes are formed according to one or more embodiments of the present disclosure. FIG. 7 is a front view of a fixing member in which generally oval through-holes are formed according to one or more embodiments of the present disclosure.

FIGS. 3 to 7 are drawings showing a fixing member 20, and a portion of the fixing member 20 of FIG. 2 is enlarged. In the drawings, sizes of the through-holes and intervals between the through-holes may be exaggerated for ease of explanation.

Referring to FIGS. 3 to 7, a plurality of through-holes 21 and 22 are formed to pass through the fixing member 20 from one end to the other end of the fixing member 20. In some examples, the fixing member 20 may have a hexahedral shape composed of four side surfaces and two wide surfaces in individual contact with respective ones of the plurality of battery cells 10, and located between adjacent ones of the battery cells 10. The plurality of through-holes 21 and 22 of the fixing member 20 may pass from one side surface among the four side surfaces to a side surface opposite thereto. The through-holes 21 and 22 may be located side by side.

Referring to FIG. 3, the plurality of through-holes 21 may be parallel to the longitudinal direction (y-direction) of the plurality of battery cells 10. In some examples, the plurality of through-holes 21 may be parallel to the direction (y-direction) in which the electrode tabs 150 of the plurality of battery cells 10 protrude. Because a portion of the electrode tab 150 that protrudes may be most vulnerable in a fall, the plurality of through-holes 21 may correspond to the longitudinal direction (y-direction) of the plurality of battery cells 10 in line with the tab portion.

The present disclosure is not limited thereto, and referring to FIG. 4, the plurality of through-holes 22 may be perpendicular to the longitudinal direction (y-direction) of the plurality of battery cells 10.

FIG. 5A is a perspective view of a fixing member 20 in which a first through-hole(s) 21 and a second through-hole(s) 22 are formed in the y- and x-directions, respectively, and FIG. 5B is a cutaway plan view of FIG. 5A. Referring to FIGS. 5A and 5B, the plurality of through-holes 21 and 22 may include a first through-hole 21 parallel to the longitudinal direction (y-direction) of the plurality of battery cells 10, and a second through-hole 22 perpendicular to the longitudinal direction (y-direction) of the plurality of battery cells 10. In this case, the first through-hole 21 and the second through-hole 22 may intersect each other perpendicularly.

Referring to FIG. 6, the cross-section of the plurality of through-holes 21 and 22 may be a circular shape. Referring to FIG. 7, the cross-section of the plurality of through-holes 21 and 22 may be formed in a substantially oval shape with a relatively long axis in a direction parallel to a width direction (x-direction) of the battery cell 10.

In some examples, a material of the fixing member 20 may be one of silicone rubber, urethane, or ethylene vinyl acetate (EVA). The present disclosure is not limited thereto, and various synthetic rubbers with high hardness may be applied.

Referring to FIGS. 6 and 7, the fixing member 20 may further include adhesive members 25 attached to each of two wide surfaces in contact with the battery cell 10. In some examples, a material of the adhesive member 25 may be acrylic, but the present disclosure is not limited thereto, and various materials of adhesive strength may be applied. The adhesive strength of the adhesive member 25 may be about 1300 g/25.4 mm or more. If the adhesive strength of the adhesive member 25 is less than about 1300 g/25.4 mm, the interface may be separated if the battery pack 1 is dropped. A thickness of the adhesive member 25 may be about 10% or less compared to a thickness of the fixing member 20 excluding the adhesive member 25.

Further, a minimum thickness Tₘᵢₙ of the fixing member 20, which is a thickness of the portion where the plurality of through-holes 21 and 22 are formed, may range from about 10% to about 30% compared to the total thickness Tₘₐₓ of the fixing member 20 including the adhesive member 25. For example, if the minimum thickness Tₘᵢₙ of the fixing member 20 is less than about 10% of the total thickness Tₘₐₓ of the fixing member 20, the strength of the fixing member 20 is reduced so that a force for movement suppression may be reduced, and if the minimum thickness Tₘᵢₙ exceeds about 30% of the total thickness Tₘₐₓ, a force for swelling absorption may be reduced.

In some examples, and referring to Equations 1, 2, and 3 below, the total thickness Tₘₐₓ and the minimum thickness Tₘᵢₙ of the fixing member 20, and a minimum diameter Dₕₒₗₑ of the through-holes 21 and 22 are determined based on a thickness BT of the battery cell 10, a set swelling rate SR, and a set compression rate CR. The set swelling rate SR represents a maximum swelling rate value compared to the thickness BT of the battery cell 10, and may be a preset value. The set compression rate CR represents a maximum compression rate of the fixing member 20 at the set swelling rate SR, and may be a preset value.

For example, the total thickness Tₘₐₓ and the minimum thickness Tₘᵢₙ of the fixing member 20, and the minimum diameter Dₕₒₗₑ of the through-holes 21 and 22, may be calculated based on Equations 1, 2, and 3 below. AT is a thickness of the adhesive member 25.

$${T}_{max} = ( BT \times SR ) + \{ ( ( BT \times SR ) \div 2 ) \times CR + ( AT \times 2 ) \} \qquad Equation 1$$

$${D}_{hole} = ( BT \times SR ) \div 2 \qquad Equation 2$$

$${T}_{min} = \{ ( {T}_{max} - ( AT \times 2 ) ) - {D}_{hole} \} \div 2 \qquad Equation 3$$

For example, if the thickness BT of the battery cell is about 6 mm, the set swelling rate SR is about 8%, the set compression rate CR is about 50%, and the thickness AT of the adhesive member is about 0.05 mm, the total thickness Tₘₐₓ of the fixing member 20 is about 0.7 mm, the minimum diameter Dₕₒₗₑ of the through-holes 21 and 22 is about 0.24 mm, and the minimum thickness Tₘᵢₙ of the fixing member 20 is about 0.18 mm.

In one or more embodiments, the total thickness Tₘₐₓ and the minimum thickness Tₘᵢₙ of the fixing member 20, and the minimum diameter Dₕₒₗₑ of the through-holes 21 and 22, may be calculated based on the thickness BT of the battery cell 10, the set swelling rate SR, and the set compression rate CR. The minimum diameter Dₕₒₗₑ of the through-holes 21 and 22 may be formed in response to the compression rate of the fixing member 20 according to the swelling of the battery cell 10.

In one or more embodiments, the area of the wide surface of the fixing member 20 may be less than or equal to the area of the battery cell 10 in contact with the wide surface. The area of the wide surface of the fixing member 20 is formed to be less than or equal to an area of a stacked surface of the battery cells 10 so that the battery cells 10 may be attached to be fixed if the battery cells 10 are stacked.

According to one or more embodiments of the present disclosure, to fix cells among the cells in a battery pack, a plurality of perforated holes, which pass through a fixing member from one side to the other side of the fixing member in a direction parallel to an attachment surface of the cell, may be formed to ensure hardness for suppressing cell movement, and to ensure a compressive force for absorbing cell swelling, thereby reducing or minimizing dead space due to a volume (thickness) of the fixing member, and thereby improving product reliability.

The aspects of the present disclosure are not limited to the above-described aspects, and other aspects that have not been mentioned can be clearly understood by those skilled in the art from the description of the present disclosure described below.

The above description is merely for implementing a secondary battery pack according to the present disclosure, and it will be understood by those having ordinary skill in the field to which the present disclosure belongs that the present disclosure is not limited to the above embodiments and includes the technical spirit of the present disclosure to the extent that various modifications may be made without departing from the spirit and scope of the present disclosure as defined by the following claims, with functional equivalents thereof to be included therein. Although the present disclosure has been described with limited examples and drawings, it is not limited thereto, and various modifications and changes are possible within the scope of the technical idea of the present disclosure and the scope of the claims to be described below by those having ordinary skill in the technical field to which the present disclosure belongs.

What is claimed is:

1. A battery pack comprising:
battery cells comprising an electrode assembly in a pouch case and comprising one or more electrode tabs; and
a fixing member between the battery cells to fix the battery cells, and defining through-holes passing from one end thereof to another end thereof.

2. The battery pack as claimed in claim 1, wherein the through-holes have a circular cross section.

3. The battery pack as claimed in claim 1, wherein the through-holes have an oval cross section with a long axis parallel to a width direction of the battery cells.

4. The battery pack according to claim 1, wherein the fixing member comprises one of silicone rubber, urethane, or ethylene vinyl acetate (EVA).

5. The battery pack as claimed in claim 1, wherein a minimum diameter of the through-holes corresponds to a compression rate of the fixing member based on a swelling of the battery cells.

6. The battery pack as claimed in claim 1, wherein the fixing member has a hexahedral shape comprising four side surfaces, and two wide surfaces contacting the battery cells.

7. The battery pack as claimed in claim 6, wherein the through-holes pass from one side surface among the four side surfaces to another side surface opposite thereto.

8. The battery pack as claimed in claim 7, wherein the through-holes are parallel to a longitudinal direction of the battery cells.

9. The battery pack as claimed in claim 7, wherein the through-holes are parallel to a direction in which the electrode tabs protrude.

10. The battery pack as claimed in claim 7, wherein the through-holes are perpendicular to a longitudinal direction of the battery cells.

11. The battery pack as claimed in claim 7, wherein the through-holes are side by side.

12. The battery pack as claimed in claim 6, wherein the through-holes comprise a first through-hole parallel to a longitudinal direction of the battery cells, and a second through-hole perpendicular to the longitudinal direction of the battery cells.

13. The battery pack as claimed in claim 12, wherein the first through-hole and the second through-hole cross each other.

14. The battery pack as claimed in claim 6, wherein an area of one of the wide surfaces of the fixing member is less than or equal to an area of a surface of the battery cell contacting the one of the wide surfaces.

15. The battery pack as claimed in claim 6, wherein the fixing member further comprises an adhesive member at one of the wide surfaces.

16. The battery pack as claimed in claim 15, wherein a minimum thickness of the fixing member between the one of the wide surfaces and one of the through-holes is about 10% to about 30% of a maximum thickness of the fixing member between the wide surfaces.

17. The battery pack as claimed in claim 15, wherein the adhesive member comprises an acrylic material.

18. The battery pack as claimed in claim 15, wherein the adhesive member has an adhesive strength of about 1300 g/25.4 mm or more.

19. The battery pack as claimed in claim 15, wherein the adhesive member has a thickness of about 10% or less than a thickness of a remainder of the fixing member excluding the adhesive member.

20. The battery pack as claimed in claim 1, wherein the battery cells are stacked in a stack type.
